(19) United States
(12) Patent Application Publication
(10) Pub. No.: US 2008/0087434 A1
(43) Pub. Date: Apr. 17, 2008

(54) Engine/steam generator with afterburner

(76) Inventors: Ronald Wilen, Paramus, NJ (US); Kenneth R. Cioletti, Wayne, NJ (US); Matthew Cioletti, Wayne, NJ (US)

Correspondence Address: KATTEN MUCHIN ROSENMAN LLP, 575 MADISON AVENUE, NEW YORK, NY, 10022-2585, US

(21) Appl. No.: 11/580,519

(22) Filed: Oct. 13, 2006

(51) Int. Cl. E21B 37/08; E21B 36/00; B09C 1/06

(52) U.S. Cl. 166/312; 166/57; 166/65.1; 166/90.1; 166/53; 405/128.4; 169/69

(57) ABSTRACT

An engine/steam generator which converts hydrogen peroxide to superheated steam and oxygen and having an afterburner that together with a reducing agent, utilizes the oxygen, thereby supplying oxygen free super-heated steam under pressure for oil well stimulation. Fluids such as water and KH30 can be injected into the engine/stem generator. The invention also relates to an apparatus and methods of incineration, soil remediation, land fill remediation, controlled vault burning, chemical atomization/vaporization, home heating, generation of electricity, diesel engine exhaust cleaning, steam turbine, gas path cleaner for jet engines, steam cleaning, natural gas engine power booster emission reducer, chemical storage tank cleaning, portable gas drive, and metal tempering.

### FIELD OF THE INVENTION

The present invention relates to an augmented apparatus and methods for stimulation and injection of geological formations, pumps, conduits and tanks, and particularly, use of an engine/steam generator with multiple stages having an afterburner. The invention also relates to methods for oil well head cleaning, down-hole, tank, deep-sea bottom pipe, and pipeline cleaning, waste incineration, soil and landfill remediation and extinguishing oil and natural gas fires.

### BACKGROUND OF THE INVENTION

When oil well production is reduced because of clogging, remedial action in the form of stimulation to improve the oil output is undertaken. A variety of stimulation and injection methods have been employed to facilitate recovery of hydrocarbons. Among these methods are treatment with chemicals such as acids, hydraulic fracturing in which liquids are injected under high pressure, explosive methods to effect mechanical fracture, and combinations of these procedures. One method is thermal stimulation which involves in-situ combustion where oxygen is injected into a reservoir and the hydrocarbons ignited in a controlled fire. One variation involves injecting hydrogen peroxide (H₂O₂), instead of oxygen, into the formation to stimulate the production of hydrocarbons. Such methods are hampered by both the uncontrolled decomposition of the H₂O₂ and safety issues involved with pumping peroxide-generating compounds into oil wells. Mechanical or chemical attempts to inhibit the premature decomposition of the H₂O₂ have been unsuccessful and found to be harmful to the formations themselves. Hydrogen peroxide can be decomposed by passing it over a catalyst. The catalyst bed decomposes the H₂O₂ to produce super-heated steam and oxygen. The hot gases formed may be used as an oxidizer. The oxygen may also be used as fuel in bi-propellant systems.

A problem exists in that the steam from the exhaust stream contains oxygen which is both corrosive and has a potential for explosion. Corrosion of oil well casings and/or inner production tubing as well as the pumps, valves and other tools in the well causes equipment failure, and perforation of pipes which leads to formation gases entering the annular space and rising. If this gas is ignited in any way, fire and explosion ensue. Specifically, any oxygen which enters the annular space combines with moisture to produce corrosive destruction and failure of the pipes and tooling. The corrosion is not only detrimental in terms of repairs but also creates ideal conditions for fire and explosion, as described above. Accordingly, it is desired to provide an augmented engine/steam generator which utilizes the excess oxygen to produce more super-heated oxygen free steam and heat.

Afterburners (or secondary combustion chambers) are often used with incinerators. However, their operation entails high fuel and operating costs. Another problem is that when used for incineration there is often a lack of oxygen in the afterburner which causes fluctuations in organic emissions or pollutants. One method used to overcome this problem has been the injection of oxygen into the afterburner. However, while injection of oxygen into the afterburner can significantly reduce organic emissions, the additional cost of oxygen is too excessive to allow uncontrolled oxygen at high enough levels to handle all pollutant fluctuations.

The present invention is directed to an engine/stream generator with multiple stages having an afterburner to inject a reducing agent directly into the exhaust stream and burn it using the remaining oxygen. The result is an oxygen free super-heated steam under pressure.

### BRIEF SUMMARY OF THE INVENTION

It is an object of the present invention to use a monopropellant engine/stream generator having an afterburner specifically configured with a reducing agent, such as hydrogen, or other reducing agents, to react oxygen and create an oxygen free super-heated steam.

It is also an object of the present invention to create a stimulation and injection system using an engine/steam generator having an afterburner which results in more efficient utilization of H₂O₂ fuel, reduced potential for corrosion, and greater safety.

It is also an object of the present invention to catalyze the decomposition of H₂O₂ in an engine/steam generator having an afterburner by either utilizing a silver screen or a silver screen coated with an actinaid or lanthanide series element, transition metal salt, or the pure elements and/or mixtures of salts and elements.

It is also an object of the present invention to catalyze the decomposition of H₂O₂ in an engine/steam generator by using a mixture of an actinaid or lanthanide series element, transition metal salt, the pure elements and/or mixtures of salts and elements plus a reducing agent which is sprayed throughout the heated inert metal screen.

It is a further object of the present invention to catalyze the decomposition of H₂O₂ in an engine/steam generator having an afterburner by injection of an actinaid series element, a lanthanide series element or a transition metal salt solution into the H₂O₂ stream to decompose without the use of a screen.

It is yet another object of the present invention to use an automated or manual control system that will allow for steam output to either include oxygen or be oxygen free or be directed to varying percentages of oxygen as desired by user interface.

It is yet another object of the present invention to inject chemicals in either gas, liquid or solid forms, into the post catalytic stream to produce steam with varying properties.

It is yet another object of the present invention to automate main controls for output temperature, output pressure, downstream oxygen content, chemical product addition proportions.

It is yet another object of the present invention to provide a method for heating prior to catalization by heating the H₂O₂ solution or slurry by means of either chemical or electronic means.

It is yet another object of the present invention to provide a method for decomposition of H₂O₂ utilizing electromagnetic flux, light and radiation ranging from infrared and microwave to ultraviolet, and plasma systems.

It is yet another object of the present invention to utilize multiple sensors to monitor exhaust oxygen and H₂ content, thermal couples for temperature and pressure at all critical locations.

It is yet another object of the present invention to provide a small vertically mounted system which can be inserted into the down-hole tubing.

It is yet another object of the present invention to provide an apparatus and method for steam flooding to extinguish oil and natural gas fires and pipeline leaks by depriving the fires of the oxygen necessary to maintain combustion.

It is yet another object of the present invention to provide an apparatus and method for oil well fracing, cleaning oil well heads, down hole paraffin dispersion/removal, tar sand oil removal, paraffin remediation of deep sea bottom pipes, pipeline cleaning, and tank cleaning using an engine/steam generator having an afterburner producing an oxygen free super-heated steam.

It is yet another object of the present invention to provide an apparatus and method for treatment of contaminated materials in soil and landfills and waste incineration using an engine/steam generator having an afterburner to produce a super-heated oxygen free steam for thermal desorption.

These novel features of the present invention will become apparent to those skilled in the art from the following detailed description, which is simply, by way of illustration, various modes contemplated for carrying out the invention. As will be realized, the invention is capable of additional, different obvious aspects, all without departing from the invention. Accordingly, the Figures and specification are illustrative in nature and not restrictive.

### BRIEF DESCRIPTION OF THE DRAWINGS

FIG. 1 is a detailed schematic of the engine/steam generator of the present invention without an afterburner.

FIG. 2 is a partial cross-sectional view of the afterburner equipped engine/steam generator according to one embodiment of the present invention.

FIG. 3 is a schematic of an electronic control unit (ECU) for the main injection valve of an afterburner equipped engine/steam generator according to one preferred embodiment of the present invention.

FIG. 4 is a simplified schematic of a tethered engine/steam generator having an afterburner component showing injection of water and KH30.

### DETAILED DESCRIPTION OF THE INVENTION

The engine/steam generator apparatus is described and claimed in copending U.S. patent application Ser. No. 10/514,395 entitled Stimulation and Injection System commonly assigned herewith, the disclosure of which is herein incorporated by reference. The design of the engine/steam generator described represents potentially infinite designs that may be used and is illustrated here for understanding of the afterburner and is therefore not intended to be limiting. Preferred unique designs are also illustrated and described in the aforementioned U.S. patent application.

The apparatus for effecting stimulation and/or injection comprises:

at least one engine/steam generator having a liquid hydrogen peroxide fuel input zone, a catalyst zone, and a zone for creating a back pressure of a steam stream formed by the engine/steam generator;

a conduit for introducing a liquid hydrogen peroxide fuel having a concentration of from about 70 to about 99 weight percent into the engine/steam generator;

an afterburner configured with reducing agent to generate an oxygen free super-heated steam; and

a means for directing the oxygen free super-heated steam into a well head, formation, pump, conduit or tank from said afterburner.

Optionally, the apparatus contains at least one means for introducing a fluid into the formation, pump, conduit or tank.

The system utilizes at least one engine/steam generator having an afterburner to produce and inject an oxygen free super-heated steam which can comprise steam, heated water, heated gas, and/or chemicals into underground formations, pumps, conduits or tanks. The system uses a stream drive under variable pressure and temperature, and chemical injection at variable pressures and temperature, which allows custom tailored cyclic drives.

The injection system has many applications due to the ability to inject an oxygen free super-heated steam at various temperatures and pressures. The super-heated steam with high pressure increases permeability which reduces the viscosity of the hydrocarbon sufficiently to facilitate the flow of the hydrocarbon fluids contained in the formation. The characteristics of steam make it effective for treating moderately deeper portions of a well. Since steam does not drop in temperature until it is completely condensed, its thermal effect passes deeper into the well, as compared to a heated liquid like hot oil. Further, saturated steam occupies sixty times the volume of water at the same temperature and pressure, and the resultant pressure acts upon the surrounding formation to aid in driving the reduced viscosity oil out of the formation. The increase in permeability is attained by fracturing the formation, by creating new flow channels or increasing the size of existing flow channels in the formation or by removing paraffin. The injection system of the invention is ideal for solving paraffin problems as well as a heavy crude and gas depleted formations as well as in pumps, conduits or tanks.

In addition, the system is environmentally clean, easy to operate, with added safety, and energy efficient. The invention possesses the multiple capability of preventing corrosion, preventing the risk of explosion, and also preventing or suppressing the spread of fires or explosions which might otherwise occur. That is, the element which contributes to corrosion, fire, and explosion, i.e. oxygen, is not available in the annular space.

The present invention is also directed to a method for afterburning oxygen from a heated steam, said method comprising:

generating an oxygen containing steam in an at least one engine/gas generator;

adding a reducing agent to said steam in an afterburner; and

producing an oxygen free super-heated steam.

In one aspect the pumps and engine/steam generator with afterburner may be present in a single location, e.g., a truck or trailer which can be rolled up to an individual well for immediate operation and then rolled up to the next well to be treated. In another aspect the engine/steam generator is placed down the oil well. In either case, the system may be completely mobile or portable.

Each pump has a drive unit and each is capable of injecting various chemicals and/or water or steam into the underground formations. Some of the pumps operate at high pressure and some operate at low pressure.

Optionally, the fuel consists essentially of hydrogen peroxide as a power source. The H₂O₂ may include additional fuel components which include, but are not limited to, appropriate storage stabilizers or chemical reaction inhibitors which are known to those skilled in the art.

Hydrogen peroxide is readily available commercially in different strengths. Preferably, high strength H₂O₂ comprises from about 70% to about 99% by weight H₂O₂. More preferably, the H₂O₂ comprises from about 90% to about 97% by weight H₂O₂. The correct percentage of H₂O₂ is determinable by those skilled in the art applicable for a particular use.

The conversion of H₂O₂ into oxygen and water vapor generates heat. As the concentration of H₂O₂ increases, the heat generated during the decomposition of H₂O₂ into water vapor and oxygen also increases. The temperatures created are from ambient up to 1,300° F. (704° C.) and the pressures are from zero to 2,500 psi. The generator can have a series of pre-heaters, electric or chemical, and is capable of decomposing various percentages of H₂O₂. The engine/steam generators have a variable pressure injection pump for injection of the H₂O₂ as well as a throttle valve to start or stop as needed.

The generators can be operated on automatic by presetting an operating temperature and sensing the controlled temperature at various locations on the well, such as with temperature sensors clamped to the well seals, and on the injection equipment. The generators have heat exchangers, one for water to regulate temperature by cooling and one for various chemicals, such as KH30 (United Energy Corporation, Secaucus, N.J.). The heat exchangers are temperature controlled at various temperatures and are selected based on the chemicals used. They are also used at variable pressures controlled by the injection pumps and their drive units.

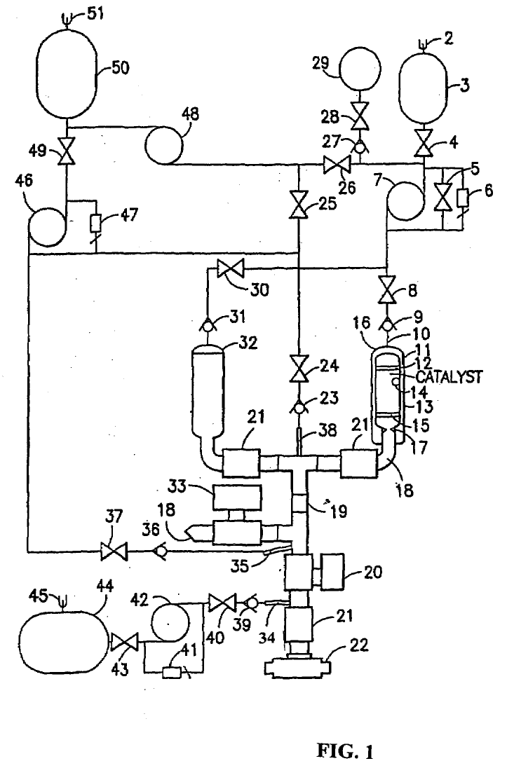

With reference to FIG. 1, a preferred embodiment of the assembly of the engine/steam generator without an afterburner is depicted in greater detail. The assembly employs two thermal (engine/steam) pressure generators (16 and 32) that can be used simultaneously with each other or individually to each other. The thermal pressure generators (TPG) are comprised of a catalyst metered injection plate (12), a catalyst (not labeled), anti-channel baffles (14), a catalyst retainer plate (15), and a venturi 0.067-0.500 (17). Each TPG is equipped with an H₂O₂ heating band (11) and a catalyst heating band (13) to be used before the initial activation of the generators, this start up temperature will ensure H₂O₂ decomposition when introduced into each catalyst bed of the two generators. A transfer pipe (10) is located between the check valves (9 and 31) and each generator (16 and 32).

The two generators are connected to the TPG tree assembly (19) by flow directors (18) which consists of heavy wall stainless steel. Between both generators are high temperature/high pressure check valves (21), which protect the generators from over-pressurization and catalyst contamination. Upon thermal pressure generator activation the vapor-containing stream is released to atmosphere through a normally open electric/pneumatic activated (EPA) vent valve (33), until the desired temperatures and system checks are met. At that moment the normally open EPA vent valve then closes in harmony with the opening of the normally closed EPA main injection valve (20) to introduce the vapor-containing stream to another high temperature/high pressure check valve (21). This check valve initially prevents the TPG tree assembly from over-pressurization and catalyst contamination. Finally, the vapor-containing stream exists through the quick connect coupling (22).

There are three injection lines located on the TPG assembly tree, one between both generators (38) which is a secondary H₂O₂ injection line. The next is the H₂O₂ primary injection line (35), located below the EPA vent valve (33). These two injection lines provide temperature control and saturation content within the vapor-containing stream. Both injection lines can be actuated simultaneously or independent of each other. The final injection line (34) located below the EPA main injection valve (20) delivers KH30 downstream in an atomized flow.

The engine/steam generator assembly is not only comprised of the TPG tree assembly but also a fluid, air and fuel supply system. These systems begin with the fuel supply, consisting of a H₂O₂ tank reservoir (3), which contains H₂O₂ that is filled and properly vented through the reservoir's fill and vent (2). Under the control of the EPA H₂O₂ supply valve (4), the EPA injection valve (8), and the EPA H₂O₂ injection valve (30) the fuel can be directed to either or both thermal pressure generators by means of the H₂O₂ pump (7). The fuel supply is then coupled right before the TPG units by check valves (9 and 31) to protect the fuel supply system. In the case of H₂O₂ pump failure, pump cavitation or any system failure, there is an EPA bypass valve (5) and a safety relief (6) surrounding the H₂O₂ pump.

The fluid systems seen in FIG. 1 consist of a water delivery and a KH30 delivery. The water supply depicted in FIG. 1 is comprised of a water tank reservoir (50) with a water tank fill/vent (51). The system routes in multiple paths to provide a failsafe for essentially any mechanical failure in the water delivery to the TPG tree assembly. The first path is controlled by the EPA primary water injection supply valve (49), which opens to introduce water to two independent water injection lines under the control of two different EPA water injection valves (37 and 24), with both lines coupled with a check valve (36 and 23) before the injection line to provide no back flow. This water injection path is powered by the primary water pump (46), and outfitted with a safety relief (47) surrounding the pump. Both water injection lines can be actuated simultaneously or independently.

The secondary path is bifold because its serves two purposes; a secondary pump back up and post TPG activation in the “cleaning” cycle or the flush system. The secondary backup system is powered by a water pump (48) which delivers water under the control of the EPA water injection secondary pump backup valve (25) to the two independent EPA water injection valves (24 and 37) in case of primary water pump (46) failure. This provides a failsafe for the temperature control and saturation content. The flush system is under control of the EPA water flush injection valve (26), the EPA bypass valve (5), and the EPA H₂O₂ injection valves (8 and 30). It is primarily powered by the secondary water pump (48), but in the case of the secondary water pump failing the flush system can be rerouted. This alternate route is under the control of the EPA primary water injection supply valve (49), the EPA water injection secondary pump backup valve (25), the EPA water flush injection valve (26), the EPA bypass valve (5), and the EPA H₂O₂ injection valves (8 and 30). The secondary routing is powered by the primary water pump (46). The flush system can only be actuated after post-activation of the thermal pressure generators. This flush system initially begins with the deactivation of the H₂O₂ pump (7), the closing of EPA H₂O₂ supply valve (4), and then the disconnection of H₂O₂ fuel delivery lines at the primary coupler directly before both thermal pressure generators. After disconnection the injection of water “cleanses” the H₂O₂ fuel delivery line of any excess H₂O₂ left within the line. The flush system also coincides with the air system, which is the second part of the flush system. It is comprised of an air purge supply (29), under control of the EPA air purge injection valve (28), the EPA bypass valve (5), and the EPA H₂O₂ injection valves (8 and 30), which when opened forces air through the previously flushed H₂O₂ fuel delivery lines. The function is to force outward and dry any water left in the H₂O₂ delivery line, making it safe and ready for transport. The air system also has its own safety feature involving an inline air purge check valve (27) to ensure nothing overcomes the air purge supply or valve.

The final fluid system, as depicted in FIG. 1, is the chemical injection system. This system is comprised of a KH30 tank reservoir (44), which is constructed with a fill/vent (45). The system is under control of the KH30 EPA injection supply valve (43) and the KH30 EPA injection valve (40), the system itself is powered by the KH30 injection pump (42) located between the two valves (40 and 43). This pump is also surrounded by a safety relief (41) to ensure the pump itself will be in a looped cycle when the KH30 injection supply valve (43) is open and the KH30 EPA injection valve (40) is closed. A check valve is positioned between the KH30 EPA injection valve (40) and the KH30 injection line (38) to provide assurance that nothing will overcome the KH30 fluid system.

The safety relief found on the H₂O₂ pump (7), the KH30 injection pump (42), and the primary water pump (46) exist because the pumps are constantly running upon primary valve actuation to provide a constant loop system for pumps when primary supply valves are open and injection valves are closed.

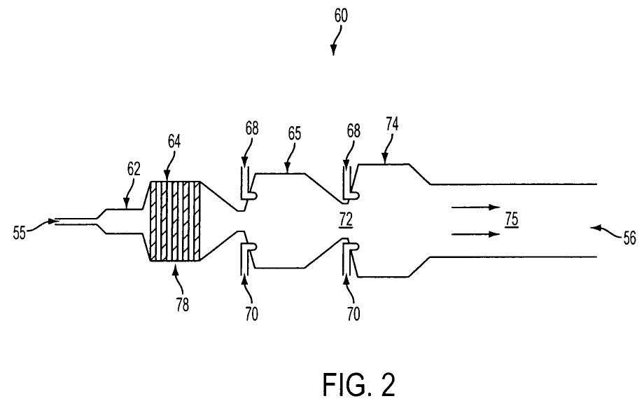

Referring now to FIG. 2, a partial cross-sectional view of an afterburner equipped engine/steam generator (60) having two engine/steam generators attached is shown. The assembly has a housing consisting of an inlet (55) and an outlet (56). Liquid H₂O₂ enters the gas generator through the inlet (55). After passing through the inlet (55), the H₂O₂ enters the pre-heat area (62) and through the catalyst bed (64). As described further in copending U.S. application Ser. No. 10/514,395, a catalyst decomposes the H₂O₂ into steam and oxygen, that exits the catalyst bed (64). The steam and oxygen then enters a second engine/steam generator (65) where it is combined with injected reducing agent (68) and injected water (70). The steam plus oxygen exits the engine/steam generator through the conduit (72) and passes to an attached afterburner (74) where it is combined with injected reducing agent (68) and water (70), producing an oxygen free super-heated steam.

The afterburner (74) is located behind the engine/steam generator (65). It should, however, be understood that, in alternate embodiments, the positioning of the afterburner may be anywhere on the engine/steam generator.

The afterburner may be continuous with the engine/steam generator. Alternatively, any suitable means of permanent or releasable attachment of the afterburner to the engine/steam generator may be used.

In a preferred embodiment, the liquid for injection is KH30 or KH30 and water. It is understood that the liquid for stimulation is not limited to KH30 and water but may be any oil well cleaning solvent, chemical, and/or acid and or mixtures thereof. The chemical may be one or more scale inhibitors, corrosion inhibitors, asphaltene dispersers and inhibitors, paraffin dispersers and inhibitors, hydrogen sulfide scavengers, hydrate inhibitors and combinations thereof. It is also understood that the liquid provides a stimulation and/or cooling function. The liquid cooling improves the overall operation of the apparatus and provides a longer life to the apparatus while providing more steam.

Scale inhibitors include water-soluble organic molecules having at least two carboxylic and/or phosphonic acid and/or sulphonic acid groups, e.g. 2-30 groups. Preferred scale inhibitors are oligomers or polymers, or monomers with at least one hydroxyl group and/or amino nitrogen atom, especially hydroxycarboxylic acids or hydroxy or aminophosphonic, or sulphonic acids. Scale inhibitors are used primarily for inhibiting calcium and/or barium scale. Examples of such compounds used as scale inhibitors are aliphatic phosphonic acids having 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each N atom, at least 2 of the numbers of methylene groups in each phosphonate being different and described further in published EP-A-479462, the disclosure of which is herein incorporated by reference in its entirety.

Other scale inhibitors are polycarboxylic acids such as acrylic, maleic, lactic or tartaric acids, and polymeric anionic compounds such as polyvinyl sulphonic acid and poly(meth)acrylic acids, optionally with at least some phosphonyl or phosphinyl groups as in phosphinyl polyacrylates. The scale inhibitors are suitably at least partly in the form of their alkali metal salts e.g. sodium salts.

Examples of corrosion inhibitors are compounds for inhibiting corrosion on steel, especially under anaerobic conditions, especially film formers capable of being deposited as a film on a metal surface e.g. a steel surface such as a pipeline wall. Such compounds may be non-quaternised long aliphatic chain hydrocarbyl N-heterocyclic compounds, where the aliphatic hydrocarbyl group may be as defined for the hydrophobic group above; mono- or di-ethylenically unsaturated aliphatic groups e.g. of 8-24 carbons such as oleyl are preferred. The N-heterocyclic group can have 1-3 ring nitrogen atoms with 5-7 ring atoms in each ring; imidazole and imidazoline rings are preferred. The ring may also have an aminoalkyl, such as, but not limited to, an 2-aminoethyl, hydroxyalkyl or 2-hydroxyethyl substituent. Oleyl imidazoline may be used. Where corrosion inhibitors are released into the formation using the method of the present invention, these inhibitors are effective in reducing corrosion of metal surfaces as they are produced out of the well. The corrosion inhibitors provide an additive corrosion inhibitory effect with the steam generated which is free of corrosion causing oxygen.

Asphaltene inhibitors include amphoteric fatty acid or a salt of an alkyl succinate while the wax inhibitor may be a polymer such as an olefin polymer e.g. polyethylene or a copolymeric ester, e.g. ethylene-vinyl acetate copolymer, and the wax dispersant may be a polyamide.

Hydrogen sulfide scavengers include oxidants, such as inorganic peroxides, e.g. sodium peroxide, or chlorine dioxide, or 1-10 carbon aldehydes such as, but not limited to, formaldehyde or glutaraldehyde or (meth)acrolein.

Hydrate inhibitors include salts of the formula [R₁ (R₂)XR₃]₊Y, wherein each of R₁, R₂ and R₃ is bonded directly to X, each of R₁ and R₂, which may the same or different is an alkyl group of at least 4 carbons, X is S, NR₄ or PR₄, wherein each of R₃ and R₄, which may be the same or different, represents hydrogen or an organic group with the proviso that at least one of R₃ and R₄ is an organic group of at least 4 carbons and Y is an anion. These salts may be used in combination with a corrosion inhibitor and optionally a water soluble polymer of a polar ethylenically unsaturated compound. Preferably, the polymer is a homopolymer or a copolymer of an ethylenically unsaturated N-heterocyclic carbonyl compound, for example, a homopolymer or copolymer of N-vinyl-omega caprolactam. Such hydrate inhibitors are disclosed in EP 0770169 and WO 96/29501 which are herein incorporated by reference.

The pumps may be driven by any suitable means such as 12 volts DC, 120 volts AC, direct drive gas engines and hydrostatic drivers. The pumps have automated drive units. Preferably there is a backup pump with a different drive in case any of the pumps fail.

The system also has monitors for formation back pressure. The system is fail-safe and cannot be operated until the engine/steam generator has reached temperatures of 350° F. and above. The system provides short injection times and is capable of producing large amounts of ceded gas. Generally the system is hooked up to a well and the H₂O₂ and/or chemicals are injected into the well at various intervals. For example, heated gas is injected into the well for about 1 minute to about 60 minutes. The temperature of the heated gas generally ranges from 15° C. to about 700° C. at the well head and at a pressure of about 1 psi to about 3000 psi above the back pressure. Then a chemical such as KH30 is injected into the well followed by additional heated gas at an increased back pressure of about 1 psi to about 3000 psi above the well back pressure. The process may be repeated and varied as needed to clean the well.

The H₂O₂ decomposition rate determines the exhaust velocity and performance. Silver-screen catalysts are used to decompose the H₂O₂. Other catalysts known to those in the art to decompose hydrogen peroxide could be used and nothing herein excludes the use of other catalysts such as, for example, nitric acid. Examples of suitable catalysts include, but are not limited to, gold, platinum, ruthenium, iridium and palladium, niobium, samarium, in addition to oxides such as manganese dioxide, or alternative catalyst systems based on combinations thereof. Preferably, the catalyst is samarium. FIG. 2 shows the catalyst bed (64) is comprised of a stack of catalyst retainer plates or mesh screens (78). The catalyst retainer plates (78) are comprised of silver screens, preferably coated with an oxidation resistant alloy such as samarium.

Preferably, the present invention is utilized with a silver screen or a silver screen coated with a Group 3 element such as actinoid or lanthanide series elements or a transition metal salt to decompose H₂O₂.

Examples of suitable actinoid series elements include, but are not limited to, actinium, americium, berkelium, californium, curium, einsteinium, fermium, lawrencium, mendelevium, neptunium, nobelium, plotonium, protactinum, thorium, uranium. Examples of suitable lanthanide series elements include, but are not limited to, cerium, dysprosium, erbium, europium, gadolinium, holmium, lanthanum, lutetium, neodymium, praseodymium, promethium, samarium, terbium, thulium, ytterium. Examples of suitable transition elements include, but are not limited to, cadium, chromium, cobalt, copper, gold, haffium, iridium, iron, lawrencium, lutetium, manganese, mercury, molybdenum, nickel, niobium, osmium, palladium, platinum, rhenium, rhodium, ruthenium, scandium, silver, tantalum, technetium, titanium, tungsten, vanadium, yttrium, zinc, and zirconium.

In one embodiment, the decomposition of H₂O₂ is catalyzed by injection of an actinaid series element, a lanthanide series element, a transition metal salt solution, or the pure elements and/or mixtures of salts and elements into the H₂O₂ stream to decompose without the use of a screen. Depending on the compound chosen the decomposition may be initiated spontaneously or by the introduction of energy into the system, by spark, plasma, laser or other coherent or incoherent electromagnetic radiation.

In another embodiment, the decomposition of H₂O₂ is catalyzed by a mixture of an actinaid series element, a lathanide series element, a transition metal salt solution, or the pure elements and/or mixtures of salts and elements plus a reducing agent sprayed throughout a heated inert metal screen.

In a typical operation, temperature in the engine/steam generator will reach about 900° F. to about 2000° F., while the temperature in the afterburner will be in the order of about 1000° F. to about 1500° F. The temperature is proportional to the percentage of H₂O₂ and is controlled by the injection of water (68) in various ports of the engine/steam generator. For example, 95% by weight H₂O₂ yields a reaction product with a decomposition temperature of 1593° F., 90% by weight H₂O₂ yields 1364° F., 80% by weight H₂O₂ yields 908° F. It should be noted that these temperatures pertain to the peroxide catalyst area. Higher temperatures are reached in areas where H₂ is reacting with the oxygen, hence the need for water injection in these stages.

When the mix comes out of the exhaust end of the apparatus for effecting stimulation and/or fracturing, it contains a substantial quantity of oxygen. The afterburner of the present invention advantageously utilizes this remaining oxygen by reacting with a reducing agent and igniting the mix, thereby forming an oxygen free super-heated steam. The oxygen flows in a downstream direction through the afterburner and is reacted therein with a reducing agent. The oxygen free superheated steam is discharged through the conduit means for directly introducing the gaseous stream.

Referring now to FIG. 2, there is shown conduits for injecting a reducing agent, here H₂ (70) and water (68) proximal to the engine/steam generator and discharging same out through ports. The amount of reducing agent added is controlled by the available oxygen concentration. Examples of suitable reducing agents include, but are not limited to, hydrogen, nitrogen containing compounds such as ammonia, hydrazine, alkylarnines, alkanolamines, but not limited to hydrocarbons such as carbon monoxide, methane, propane, ethane, alcohols such as, but not limited to, methanol, ethanol, propanol, common diesel fuels such as gasoline, diesel oil, and the like, tetrahydrofuran, furfuryl alcohol, tetrahydrofurfuryl alcohol (THFA), tetrahydrofurfuryl and the like and mixtures, derivatives and combinations thereof.

It is apparent that the instant apparatus by virtue of its recycling use of the oxygen exhaust from the engine/gas generator in the afterburner, is extremely energy efficient. That is, it has a very high operating efficacy and is substantially regenerating. Moreover, inasmuch as H₂O₂ does not normally give rise to any contamination problems, the method is environmentally friendly.

The construction and operation of such afterburners are well known and need not be described in detail here. However, in an exemplary embodiment, the afterburner comprises one or more fuel injectors, a tube, a flame holder that the fuel burns in, and an adjustable nozzle. The afterburner includes an inlet end for receiving the superheated steam and reducing agent to react oxygen and an outlet end for discharging an oxygen free superheated steam from the afterburner. The afterburner may either be circumferentially bounded or circumferentially continuous and should be light weight, low cost and with minimal complexity. The afterburner is preferentially made from a material with a high thermal capacity such as high temperature steel, although the material is not critical so long as it can withstand a temperature of about 2200° F.

The apparatus can further comprise means for introducing a H₂O₂-containing fluid into the formation, pump, conduit or tank downstream of the means for directing the vapor-containing stream into the formation, pump, conduit or tank. The vapor-containing stream is at a temperature of at least about 350° F. The apparatus can further include means for flushing the conduit as well as the formation, conduit, pipe or tank prior to introducing the vapor-containing stream into the formation, conduit, pipe or tank as well as valve-means in the conduit for venting to atmosphere said vapor-containing stream. The apparatus can also have a second valve-means for cooperating with the valve-means to effect flow of the vapor-containing stream into the conduit, pipe, conduit or tank with concomitant discontinuance of venting flow.

It should also be noted that while oxygen is preferably utilized in the afterburner to provide an oxidizing source, any oxygen mixture, either in gaseous or liquid form may be utilized. For example, a liquid mixture composed of high concentration of oxygen as well as other chemicals may be utilized.

While hydrogen peroxide is the preferred fuel, any suitable peroxide or oxygen-generating compound such as, but not limited to, sodium percarbonate, sodium perborate, ammonium percarbonate, ammonium nitrate, nitrous oxide, calcium hypochlorite, may be used in accordance with the present invention. Particularly preferred other oxidizers are ammonium dinitramide, ammonium nitrate, aminoguanidine dinitrate, hydroxylamine nitrate, hydrazine nitrate, and ammonium perchlorate. In all cases the ammonium salts may be replaced by the sodium or potassium salts.

While the preferred embodiment is bi-propellant, the invention may be mono-propellant or multi-propellant. Preferably, the present invention comprises a bi-propellant of H₂O₂ and a reducing agent. More preferably, the hydrogen peroxide bi-propellant consists essentially of H₂O₂ and H₂.

In other embodiments, other fuels may be used. Preferred fuels are hydrogen, water soluble alcohols, diesel, amines, amine nitrates, polyvinyl nitrate, hydroxyethyl hydrazines, derivatives of guanidine and aminoguanidine, and azoles such as 5-aminotetrazole. Examples of preferred guanidine and aminoguanidine derivatives include guanidine nitrate, aminoguanidine nitrate, and triaminoguanidine nitrate.

In another embodiment, the fuel used could be hydrogen (H₂) where the only reaction product is steam where the H₂ is burned in the afterburner. While using H₂ avoids problems with dangerous reaction products, the use of H₂ requires suitable safety measures in view of its high volatility.

The present invention provides many advantages over existing engine/steam generators. Unlike existing systems, the present invention provides an oxygen free super-heated steam which results in more efficient utilization of H₂O₂ fuel. Via use with the afterburner, there is more efficient energy output per pound of fuel. Compared with conventional engine/steam generators, the present invention provides reduced fuel rates. The afterburner heats and expands the exhaust gas further, and can increase the thrust of the gaseous stream to be introduced into the hydrocarbon bearing well formation.

In addition, there is a reduced potential for corrosion in that no oxygen is injected into the down hole or in pipelines, tanks, or the like. Importantly, the present invention is safer than existing engines/steam generators in that the absence of oxygen injection greatly reduces the risk of explosions.

In one embodiment, the main controls for output temperature, output pressure, downstream oxygen content, chemical product additions proportions are automated. Multiple chemical additions are then possible with multiple staging. Additionally, temperature controls for preheat of H₂O₂ and chemical additives are possible. The system will also control and monitor the production of high concentration of H₂O₂.

The controller may be a computer or other device which is operatively joined to the engine/steam generator to control the operations of the engine in a typical manner, and additionally controls operation of the afterburner. This is typically effected by suitable control algorithms or software in the controller. Temperature controls may be effected by one or more temperature monitoring devices positioned at a number of locations on the engine/steam generator, and afterburner to maintain the desired temperature.

In one preferred embodiment, part of the controlling means comprises a thermocouple located in the outlet end of the afterburner which provides a temperature sensor with the instantaneous temperature of the oxygen free gaseous stream exhausted through the outlet end of the afterburner.

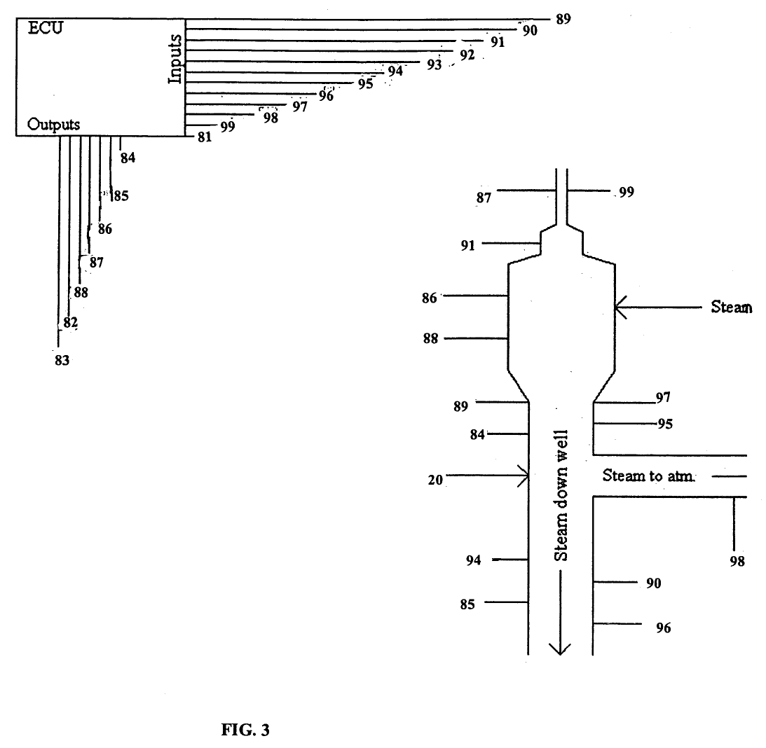

In another embodiment, the system may be computerized and monitor heat and flow. Referring now to FIG. 3, there is shown an electronic control unit (ECU) for the main injection valve (20) engine/steam generator with afterburner. The ECU is responsible for automation of all steam generation control. It automates the warm up process and in case of emergency, initiates the shut down and flush process. From the user defined input parameters the ECU will regulate the injection of fuels, water and cleaner and the operation of the EPA valve, to maintain specified operating conditions. The controller may, therefore, be specifically configured to schedule reducing agent flow to the afterburner. The bore size between each stage should increase in size as needed to allow a lower pressure in each progressive stage. The stages can be equipped with pressure, temperature, and oxygen content if desired. The key to the ECU is as follows:

(81) User interface, user defined-oxygen content, output temperature, output pressure, cleanser injection (e.g. KH30)

(82) Emergency shutdown/flush initiate

(83) EPA vent valve control for warm up and pressure regulation

(84) Post afterburner water injection, used to control steam output pressure

(85) KH-30 injection

(86) Hydrogen injection includes stages and afterburner (More than one will be required if separate stage/afterburner control is required)

(87) H₂O₂ injection

(88) Water steam engine injection, used to lower internal temperature (to be deleted if engine does not have multiple stages)

(89) Steam engine output temp sensor, used for safety shutdown

(90) Output temperature sensor

(91) Catalytic pre-heat sensor

(92) EPA vent temperature sensor used during warm-up cycle

(93) EPA vent oxygen sensor

(94) Output oxygen sensor

(95) Upstream oxygen sensor used with downstream (93, 94) for hydrogen enrichments (oxygen sensors assumed to be wide band)

(96) Output pressure sensor

(97) Steam engine output pressure sensor used for emergency shutdown

(98) EPA vent pressure sensor

(99) H₂O₂ pressure sensor used for emergency shutdown

In another embodiment of the present invention, there is provided multiple sensors to monitor oxygen exhaust, H₂ content, thermocouple sensors for temperature, flow, and pressure at all critical locations.

In another embodiment there is a portable methodology for producing 70-99% by weight H₂O₂ by enriching low concentration H₂O₂ solutions on site. This reduces shipping and handling costs due to Haz-Mat constraints, reduces safety and storage concerns and significantly reduces fuel costs.

In another aspect, the present invention is a method for heating prior to catalization by heating the solution or slurry by means of either chemical or electronic means.

In yet another embodiment of the present invention, there is provided a method for decomposition of H₂O₂ utilizing electromagnetic flux, light and radiation ranging from infrared and microwave to ultraviolet, and plasma systems, including but not limited to, those used for metal cutting tools. The method consists of spraying H₂O₂ into an enclosed chamber and subjecting it to either diffuse or directed radiation in the form of a laser or maser in frequencies ranging from microwaves on the long wavelength/low frequency end to UV radiation on the high frequency short wavelength end.

In yet another embodiment of the present invention, there is provided a small vertically mounted system which can be inserted into the down-hole tubing. This system is capable of performing all the functions of the larger unit. As an example, a tethered system could be inserted down hole to depths of from about 5,000 to about 25,000 feet. This allows for direct heat application thousands of feet below the surface.

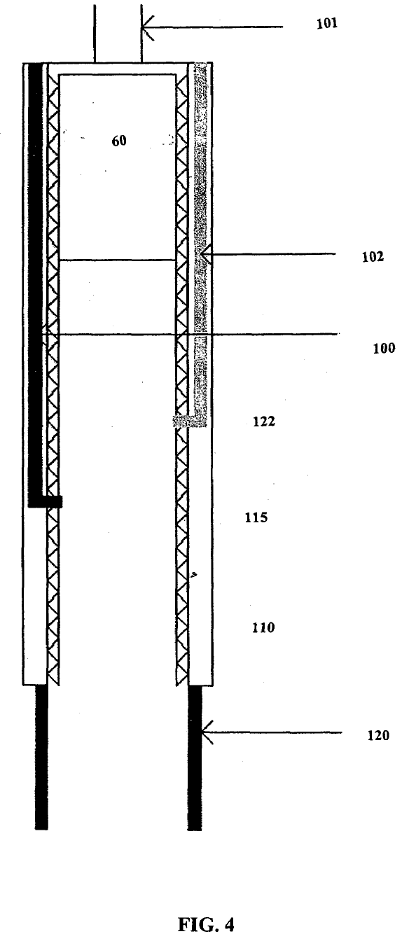

Referring also to FIG. 4, there is provided a tethered application where the engine/steam generator (60) is mounted via a tether (101) inside a triple walled pipe (110). The outer pipe (115) contains the hoses (100) for water and cleaner (102), the wiring for the lowered mounted sensors and the wiring for the nozzle/diffuser actuators (120). The mid-pipe (122) contains either insulation or can be filled with coolant. The tethered apparatus can have a depth limited to the tether length. The apparatus uses less fuel, because the hot steam is brought to the area being cleaned. The nozzle will allow for a diffused standard cleaning process or a directed high pressure blockage piercing stream.

The following examples describe specific aspects of the invention to illustrate the invention and provide a description of the present methods for those skilled in the art. The Examples should not be construed as limiting the invention as the examples merely provide specific methodology useful in the understanding and practice of the invention and its various aspects.

The present invention is also applicable for other methods of oil well stimulation such as fracing. fracing. Fracing involves the use of high pressure, high temperature or both to open up pores in a formation.

The invention may also be used as a steam cleaning system to clean well heads with or without introduced chemicals.

Accumulation of clogging hydrocarbons (most of which are paraffin based) within the production tubing of oil wells is major problem experienced throughout the industry. As the buildup progresses, the flow of fluids becomes progressively prevented requiring servicing of the well for removal. Various mechanical, chemical and electrical systems have been utilized to prevent paraffin buildup from interfering with the production of fluids through the production tubing.

Steam injection has been used to treat hydrocarbon clogging by thermal reduction of its viscosity. However, a problem with prior steam injection methods is that they are not portable and are inefficient resulting from poor boiler design, resulting in high operating costs, such that the cost advantage of steaming a clogged well often exceeded the economic benefits of improved production.

The apparatus of the present invention is applicable for inexpensive and dependable removal of downhole paraffin buildup. The method for removal of paraffin buildup using an engine/steam/generator with afterburner involves:

tethering an engine/steam generator as in claim 1 on a wire line, a tubing or a rod;

positioning the engine/steam generator downhole into an oil well to a desired position along said oil well production tubing; and

pumping an oxygen free super-heated steam through the interior of the production tubing thereby removing paraffin.

The high temperature of the super-heated steam raises the temperature of the accumulated paraffin deposits along the interior of the tubing to a temperature above the cloud point of paraffin thereby releasing the accumulated paraffin deposits. Additionally, the present method may be performed without extended interruption of the production from the well.

The invention is also useful for production of steam under pressure to remove oil and tar deposits from deposits and bring liquified tar to the surface under pressure with or without booster chemicals.

The apparatus and system of the invention may also be used for paraffin remediation from deep sea bottom pipes. In this method, heat which is created loosens the deposits of paraffin and asphaltene and gas hydrate deposits are loosened by injection from surface or introduction of an in-pipe unit.

The apparatus and afterburner may be used for a number of steam cleaning operations. For example, pipeline cleaning in a pig both as a source of heat (steam) or propulsion (short term) for removing blockages. The apparatus is also useful as a steam cleaner with or without additional chemicals to remove oil deposits from all internal surfaces of tank. Moreover, it is also used to loosen accumulated sludge on the tank bottom. Additionally, the invention is useful for chemical storage tank cleaning.

In another aspect, the present invention is useful for in situ decomposition of methane hydrate deposits. The super-heated steam of the present invention may be used to melt the methane hydrates to release methane.

Steam Flooding to Extinguish Oil and Natural Gas Fires

The invention also relates to methods for extinguishing the flame of a burning oil well, wellhead, natural gas wells and pipelines. Such fires are best extinguished by preventing oxygen from reaching the combustible materials, cooling the combustible materials below their ignition temperature, and/or removing the source of combustible materials. In some cases, large amounts of explosives are brought in and detonated on or above the base of the fire to consume or interrupt the supply of oxygen, thereby extinguishing the fire. Other methods involve concrete caps and foams.

The production of high pressure, oxygen free steam of the present invention is useful to extinguish above ground or below ground fires. The apparatus of the invention is also useful for controlling underground coal fires by injection of high pressure steam. The method of the invention allows knock-down and fire extinguishment time to be markedly reduced over conventional methods. The method may also be used for pipeline leaks. The fire extinguishing method deprives the fire of oxygen necessary to support combustion and comprises:

positioning an engine/steam generator with an afterburner about the base of a fire; and

delivering oxygen free high pressure steam from a conduit means to the oil fire. This prevents oxygen from reaching the fire and smothers the fire, thereby extinguishing the flames.

Waste Incineration

In addition to use for engine/steam generator oil industry related applications, the present invention is applicable to a number of methods for the treatment of contaminated materials, for example, hospital and other waste incineration and soil remediation/passivation. The invention can be adapted to a broad range of regulatory applications including conventional solid waste incineration, medical waste treatment, CERCLA wastes and RCRA hazardous waste.

There are several variations on the use of H₂O₂ as a specialty chemical to enhance the performance of existing incinerators. H₂O₂ injection can be adapted to a broad range of incinerator technologies such as, but not limited to, rotary kiln, traveling grate mass burn, tangentially fired and vertical H₂O₂ wall boilers, fluid bed and RDF configurations.

The invention includes adoption of H₂O₂ to “thermal desorption” technologies. Thermal desorption and flameless destruction technologies are currently the only technologies permitted. Thermal desorption is a physical separation process employed for removal of organic material such as soil, sludge, and filter cake, which is typically carried out using a direct fired rotary dryer followed by a baghouse, thermal oxidizer such as an afterburner or incinerator for gases, H₂O quench to cool the gases, packed scrubber, and stack for emission of gases.

Thermal desorption methods which utilize superheated steam have been described in U.S. Pat. No. 5,656,178 directed to a multi-stage process with closed loop superheated steam recycle and the publication Thermal Desorption by Steam Stripping/Solid Waste Desorption, Texarome, Inc., EPA SITE Technology Profile, pp. 152-153, November 1991. This process, also known as the Texarome process recycles H₂O instead of steam, thereby rendering the process significantly more expensive in terms of energy costs, less efficient and more time consuming in view of the need to first condense all generated vapors and then revaporize the liquids for use in the process. Other methods use thermal oxidizers which are costly to purchase, set up, and operate. The capital expense of vapor treatment is very high (over one million dollars). Additionally, thermal oxidizers may be large and heavy units that are expensive to mobilize.

The afterburner added to the process removes virtually all smell and remaining particulate matter from the waste gases in the form of smoke from the output of incineration. This occurs because the incoming exhaust has enough oxygen present to fully oxidize the pollutants present.

The present invention provides an improved afterburner apparatus for producing an oxygen free substantially pollution free exhaust. Unlike previous methods where the amount of energy necessary was cost prohibitive, the method of the invention may be employed to process large amounts of waste quickly and cost effectively.

Soil Remediation/Passivation

In one embodiment the invention is useful for soil remediation/passivation. The engine/stream generator with afterburner is used to heat remediation formulas for injection into contaminated soil for separation of organic and inorganic contaminants. Similarly, the invention is useful for remediation of landfills.

According to the invention, there is provided a method for treatment of materials contaminated with environmentally significant amounts of pollutants or constituents, said method comprising the steps of: generating superheated steam via the decomposition of H₂O₂ in an engine/steam generator augmented with an afterburner;

producing an oxygen free superheated steam;

subjecting contaminated solid material to the superheated steam whereby volatilizable components thereof are volatilized and separated from the solids;

recycling the gas stream comprising the superheated steam; and

continuing the recycling until the pollutants or constituents are separated to environmentally insignificant amounts.

The method of this invention is applicable to waste materials of various types including surface impoundment sludges; contaminated soils; river sediments; bedrock; alluvium, and particulate fill materials such as cinders, gravel, etc; solid waste materials including industrial chemicals and synthetics, specialty chemicals, coke, and coal-tar chemicals; organic contaminants such as, but not limited to, halogenated volatiles or semivolatiles, nonhalogenated volatiles or semivolatiles, polychlorinated biphenyls, pesticides, dioxins/furans, organic cyanides, organic corrosives, and inorganics such as volatile metals and the like.

As referred to herein, environmentally insignificant amounts are those within the limits prescribed by government regulations.

The above method may be conducted as a closed loop system or alternatively, utilizing an enclosed treatment zone. The closed system may involve a pressured rotary drum or other vessel known to those skilled in the art.

It can be seen from the above that the present method represents a decided and significant improvement over the methods employed in conventional thermal desorption processes. Use of superheated steam for thermal desorption makes the process more cost effective and reduces the partial pressure of organic pollutant components permitting their volatilization at atmospheric pressure from contaminated solids at temperatures that are much lower than their normal boiling points without the necessity of operating under vacuum conditions as in prior methods. Additionally, to avoid combustion, other methods for thermal desorption require the continuous pumping of an inert gas, such as nitrogen to maintain a substantially oxygen-free atmosphere within the susceptor tube. The oxygen free steam of the present invention omits this requirement and minimizes the potential for combustion or constituent oxygenation. Moreover, the process is energy efficient and therefore, more effective and less expensive than the known methods for soil or landfill remediation. While the use of H₂O₂ with or without oxygen to increase cleaning efficacies on a variety of soils is described, injection of cleaning chemicals also embodied herein.

The present invention will be of immediate relevance and applicability to the gas and electric utility industries and owners of former manufactured gas plants (MGP) sites with soils contaminated with coal tar residues. The technology could also be applicable to wood treatment sites contaminated with creosotes, to coke plant sites, to gas works sites contaminated with gas condensate residues, and to petroleum refineries and petroleum storage facilities (such as tank farms) that have been contaminated with heavy oil fractions.

It is understood that the engine steam/generator with afterburner/multiple stages may be utilized for any application which utilizes oxygen free steam. A list of such applications includes, but is not limited to, a method for controlled vault burning, chemical atomization/vaporization, home heating, generation of electricity, exhaust cleaning of diesel engines, gas path cleaning of jet engines, steam cleaning, steam turbines, chemical storage tank cleaning, metal tempering, portable gas drive, chemical atomization/vaporization, and a natural gas engine power booster emission reducer using an engine/steam generator having an afterburner producing an oxygen free super-heated steam.

The invention is also useful for chemical atomization/vaporization. The introduction of inorganic or organic solutions into the produced steam from the decomposition of hydrogen peroxide increases the efficiencies of vaporization and/or dispersion of the solution.

For diesel engines-exhaust the invention is useful for cleaning the injection of byproducts of decomposition oxidizes the unreacted carbinaceous byproducts of diesel combustion.

For steam turbines the invention is useful for the production of high pressure steam to run turbines with little or no warm-up time. The combination of H₂O₂ decomposition products with additional H₂O can increase the mass of steam produced to run the turbines.

The invention is also useful for gas path cleaners on jet engines the use of high pressure steam from H₂O₂ decomposition plus injected cleaners increases cleaning efficacies of gas path cleaners for jet turbines

As a natural gas engines-power booster emission reducer, increase combustion efficacy is possible via the present invention by introducing steam and oxygen into the gas either pre- or post-combustion.

For a portable gas drive, the use of the high pressure steam of the invention may drive a gas turbine driven engine.

For metal tempering, the use of high temperature steam of the invention is useful to heat carbon and stainless steel to case harden the metal or to decrease brittleness (i.e., temper) of cast parts.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

1. A system and apparatus for effecting stimulation and/or injection, which comprises:
at least one engine/steam generator having a liquid hydrogen peroxide fuel input zone, a catalyst zone, and a zone for creating a back pressure of a steam stream formed by the engine/steam generator;
a conduit for introducing a liquid hydrogen peroxide fuel having a concentration of from about 70 to about 99 weight percent into the engine/steam generator;
an afterburner configured with one or more reducing agents to generate an oxygen free super-heated steam; and
a means for directing the oxygen free super-heated steam into a well head, formation, pump, conduit, or tank from said afterburner.

2. The system and apparatus for effecting stimulation and/or injection according to claim 1, wherein said reducing agents are selected from the group consisting of hydrogen, nitrogen containing compounds, hydrazine, alkylamines, alkanolamines, hydrocarbons, common diesel fuels, tetrahydrofuran, furfuryl alcohol, tetrahydrofurfuryl alcohol (THFA), and tetrahydrofurfuryl, and salt, derivatives and mixtures thereof.

3. The system and apparatus for effecting stimulation and/or injection according to claim 2, wherein said reducing agent is hydrogen.

4. The system and apparatus for effecting stimulation and/or injection according to claim 1 further comprising a controller, wherein said controller is configured to schedule reducing agent flow to said afterburner.

5. The controller of claim 4 which is an electronic control unit.

6. The system and apparatus for effecting stimulation and/or injection according to claim 1 further comprising a means for introducing one or more liquids proximal to the engine/steam generator to stimulate oil flow.

7. The engine/stream generator of claim 6 wherein said one or more liquids is a chemical which stimulates oil flow selected from the group consisting of one or more scale inhibitors, corrosion inhibitors, asphaltene dispersers and inhibitors, paraffin dispersers and inhibitors, hydrogen sulfide scavengers, hydrate inhibitors, water and combinations thereof.

8. The system and apparatus for effecting stimulation and/or injection according to claim 7 wherein said chemical is the paraffin disperser and inhibitor KH30.

9. The system and apparatus for effecting stimulation and/or injection according to claim 1 wherein the catalyst zone contains at least one catalyst selected from the group consisting of a metal and a metal oxide.

10. The system and apparatus for effecting stimulation and/or injection according to claim 9 wherein the at least one catalyst is samarium.

11. The system and apparatus for effecting stimulation and/or injection according to claim 1 further comprising a silver screen to decompose H₂O₂.

12. The system and apparatus for effecting stimulation and/or injection according to claim 11 further comprising a silver screen coated with a Group 3 element selected from the group consisting of a actinoid series element, a lanthanide series elements, a transition metal salt, and mixtures, derivatives or salts thereof.

13. A method for afterburning oxygen from heated steam for use in a stimulation and/or injection system said method comprising:
providing oxidizing fuel to an at least one engine/steam generator;
utilizing at least one catalyst to decompose the oxidizing fuel;
generating an oxygen containing steam in the engine/gas generator;
adding a reducing agent to said steam in an afterburner; and
producing an oxygen free super-heated steam.

14. The method of claim 13 wherein the oxidizing fuel is essentially hydrogen peroxide.

15. The method of claim 14 wherein the hydrogen peroxide has a concentration of between about 70% to about 99% by weight.

16. The method of claim 13 wherein the catalyst is selected from the group consisting of a metal and a metal oxide.

17. The method according to claim 16 wherein the at least one catalyst is samarium.

18. The method according to claim 14 further comprising a silver screen to decompose H₂O₂.

19. The method according to claim 18 wherein said silver screen is coated with a Group 3 element selected from the group consisting of a actinoid series element, a lanthanide series elements, a transition metal salt, and mixtures, derivatives, and salts thereof.

20. A system and apparatus for oil well fracing, cleaning oil well heads, down hole paraffin dispersion/removal, tar sand oil removal, paraffin remediation of deep sea bottom pipes, pipeline cleaning, and tank cleaning comprising an at least one engine/steam generator having an afterburner as in claim 1 to produce an oxygen free super-heated steam.

21. A system and apparatus as in claim 1 for oil well fracing, cleaning oil well heads, down hole paraffin dispersion/removal, tar sand oil removal, paraffin remediation of deep sea bottom pipes, pipeline cleaning, and tank cleaning.

22. A system and apparatus as in claim 1 for disposing of materials contaminated with environmentally significant amounts of pollutants or constituents to produce substantially pollution free exhaust.

23. A method for treatment of materials contaminated with environmentally significant amounts of pollutants or constituents, said method comprising the steps of:
providing oxidizing fuel to an engine/gas generator as in claim 1;
generating superheated steam from catalytic decomposition of H₂O₂ in an engine/steam generator augmented with an afterburner;
producing an oxygen free superheated steam;
subjecting contaminated solid material to the superheated steam whereby volatilizable components thereof are volatilized and separated from the solids;
recycling the gas stream comprising the superheated steam; and
continuing the recycling until the pollutants or constituents are separated to environmentally insignificant amounts.

24. The method of claim 23 in which the contaminated solid material is selected from the group consisting of medical waste, solid waste, CERCLA waste, and RCRA waste.

25. The method of claim 23 wherein said contaminated solid material is found in soil or a landfill.

26. A system and apparatus as in claim 1 for extinguishing a fire burning from an oil or natural gas well or a pipeline.

27. A method of extinguishing a fire burning from an oil or natural gas well or a pipeline comprising:
positioning an engine/steam generator with afterburner as in claim 1 about the base of the fire, and;
delivering an oxygen free super-heated steam through a conduit means thereby preventing oxygen from reaching the fire.

28. A method for removal of paraffin buildup from oil well production tubing comprising:
tethering an engine/steam generator as in claim 1 on a wire line, a tubing or a rod;
positioning the engine/steam generator downhole into an oil well to a desired position along said oil well production tubing; and
pumping an oxygen free super-heated steam through the interior of the production tubing thereby removing paraffin.

29. The method of claim 28 further comprising introducing one or more liquids proximal to the engine steam generator.

30. A method for controlled vault burning, chemical atomization/vaporization, home heating, generation of electricity, exhaust cleaning of diesel engines, gas path cleaning of jet engines, steam cleaning, steam turbines, chemical storage tank cleaning, metal tempering, portable gas drive, chemical atomization/vaporization, and natural gas engine power booster emission reducer, said method comprising use of oxygen from super-heated steam from the engine/steam generator with afterburner as in claim 1.

31. The method for afterburning oxygen from heated steam for use in a stimulation and/or injection system as in claim 13, said method further comprising:
heating prior to catalization by heating the solution or slurry by chemical or electronic means.

32. The method for afterburning oxygen from heated steam for use in a stimulation and/or injection system as in claim 13, said method further comprising: decomposing H₂O₂ by a method selected from the group consisting of electromagnetic flux, light and radiation ranging from infrared and microwave to ultraviolet, and plasma systems.

33. The method for afterburning oxygen from heated steam for use in a stimulation and/or injection system as in claim 13, said method further comprising: decomposing H₂O₂ by injection of an actinaid series element, a lanthanide series element or a transition metal salt solution into the H₂O₂ stream to decompose without the use of a screen.

34. The method for afterburning oxygen from heated steam for use in a stimulation and/or injection system as in claim 13, said method further comprising: monitoring at all critical locations oxygen exhaust, H₂ content with multiple sensors; monitoring temperature with thermocouples; and monitoring flow and pressure.

35. The method for afterburning oxygen from heated steam for use in a stimulation and/or injection system as in claim 13, said method further comprising: injecting of chemicals in a form selected from the group consisting of gas, liquid and solid, into the post-catalytic stream; and producing steam with varying properties.

36. The system and apparatus of claim 4, wherein said controller is automated to provide outputs for temperature, output pressure, downstream oxygen content, chemical product additions and proportions.

37. The method for afterburning oxygen from heated steam for use in a stimulation and/or injection system as in claim 13, said method further comprising an automated or manual control system that will allow for steam output selected from the group consisting of steam containing oxygen, oxygen free steam, and steam containing varying percentages of oxygen as desired by a user interface.

38. A system and apparatus as in claim 1, whereby said apparatus and system is of a size and vertically mounted system such that it can be inserted into down-hole tubing.
